(19) United States
(12) Patent Application Publication
(10) Pub. No.: US 2007/0162388 A1
(43) Pub. Date: Jul. 12, 2007

(54) Method and system for automated teller machine configuration

(75) Inventors: Andrew Hamilton, Dundee (GB); Stephen Neil MacPhail, Dundee (GB); Wolf Rossmann, Forfar (GB)

Correspondence Address: JAMES M. STOVER;NCR CORPORATION, 1700 SOUTH PATTERSON BLVD, WHQ4, DAYTON, OH, 45479, US

(73) Assignee: NCR Corporation

(21) Appl. No.: 11/327,943

(22) Filed: Jan. 9, 2006

(51) Int. Cl. G06Q 40/00

(52) U.S. Cl. 705/43

(57) ABSTRACT

Methods, systems, and software are disclosed for configuring an ATM. The ATM receives one or more configuration messages in an XML-based format. The ATM interprets the one or more configuration messages. The ATM restricts one or more ATM operations based on at least a portion of the one or more configuration messages.

### CROSS-REFERENCE TO RELATED APPLICATION

This application claims priority to commonly owned U.S. provisional patent application, NCR Docket No. 12411, filed Dec. 26, 2005, entitled “Method and System for Automated Teller Machine Configuration,” by Andrew Hamilton, Wolf Rossmann, and Stephen MacPhail.

### BACKGROUND

Automated teller machines (sometimes abbreviated as ATMs) can be configured to allow users to perform various financial transactions at any time. For example, many banks have one or more ATMs from which users may withdraw cash from a checking or savings account that corresponds to a card provided by the user. ATMs can also include devices called financial self-service terminals and kiosks. ATMs can perform one or more of a large number of customer transactions in addition to simply withdrawing cash such as depositing cash or checks in an account, checking the balance in an account, and transferring funds between accounts. ATMs can also perform one or more of a large number of administrative transactions including updating ATM software and replenishing the cash supply of the ATM.

Within the context of an ATM transaction, the financial institution that operates the ATM may be referred to as the acquiring institution or acquiring bank. The financial institution that holds the account of the ATM user and issues the ATM card to the user may be referred to as the issuing institution or issuing bank.

### SUMMARY

In general, in one aspect, the invention features a method for configuring an ATM. The ATM receives one or more configuration messages and interprets the one or more configuration messages. The ATM alters one or more restrictions of one or more ATM operations based on at least a portion of the one or more configuration messages. The one or more configuration messages are in an XML-based format. XML stands for eXtensible Markup Language.

In general, in another aspect, the invention features a system for configuring an ATM. The system includes an ATM that is configured to receive and interpret one or more configuration messages. The ATM is also configured to alter one or more restrictions of one or more ATM operations based on at least a portion of the one or more configuration messages. The system also includes a communication link coupled to the ATM and a computer coupled to the communication link. The ATM is configured to receive the one or more configuration messages in an XML-based format.

In general, in another aspect, the invention features software for configuring an ATM. The software includes executable instructions cause the ATM to receive and interpret one or more configuration messages. Based on at least a portion of the one or more configuration messages, the ATM alters one or more restrictions of one or more ATM operations. The one or more configuration messages are in an XML-based format

### BRIEF DESCRIPTION OF THE DRAWINGS

FIG. 1 is a diagram of a system for configuring an ATM according to one exemplary embodiment.

FIG. 2 is a diagram of a system for configuring an ATM according to one exemplary embodiment.

FIG. 3 is a flow chart of a method for configuring an ATM according to one exemplary embodiment.

FIGS. 4-5 are block diagrams of data structures according to two exemplary embodiments.

FIG. 6 is a flow chart of a method of using a configured ATM according to one exemplary embodiment.

FIG. 7 is a flow chart of a method of querying an ATM according to one exemplary embodiment.

### DETAILED DESCRIPTION

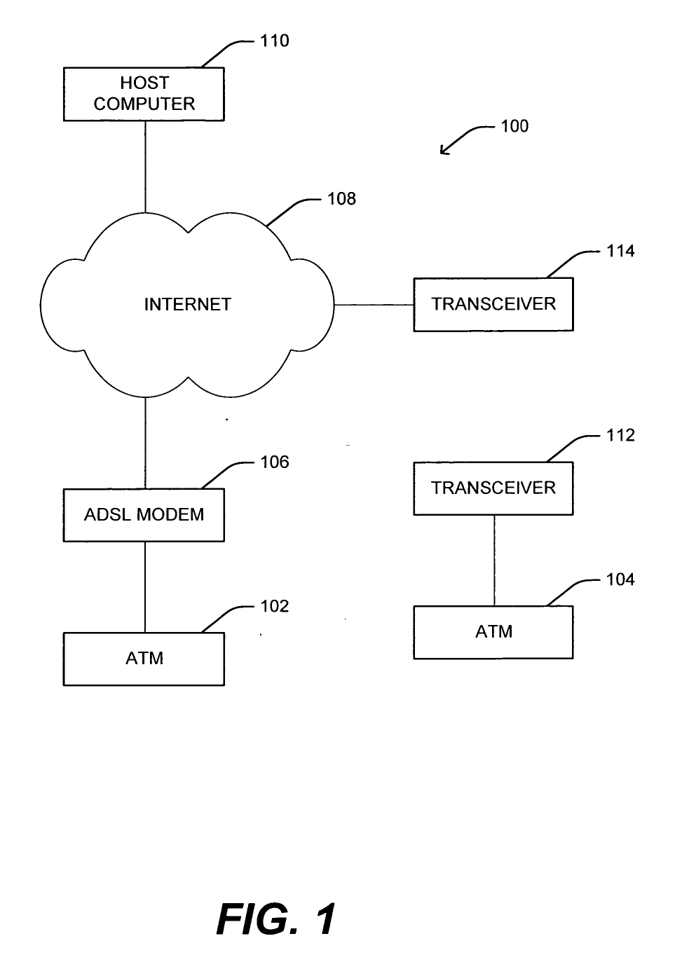

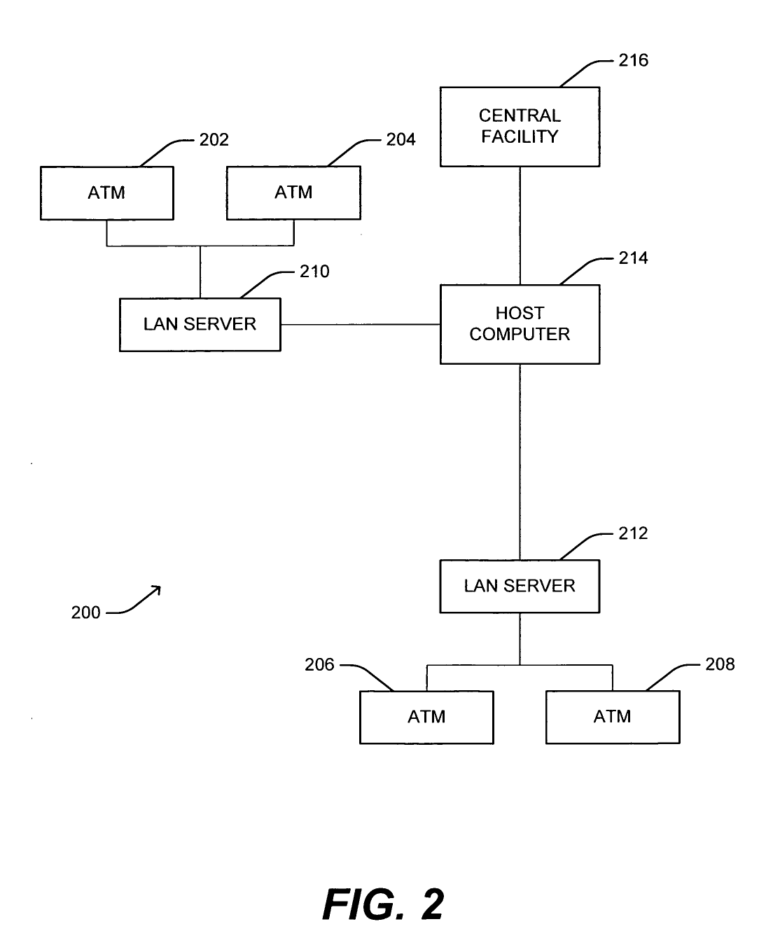

The ATM configuration techniques disclosed herein have particular application, but are not limited, to groups of ATMs that are networked together for central administration. FIGS. 1 and 2 illustrate different embodiments of system configurations for configuring ATMs in a manner that provides error detection through transmission of log information. Those systems are exemplary and many different systems for coupling a computer to a ATM using a communications link can be utilized with various communications technologies.

In FIG. 1, the system 100 includes two ATMs 102, 104, each with a communications link to a host computer 110. In the FIG. 1 embodiment, the host computer is coupled to the Internet 108. ATM 102 communicates with a computer in the Internet 108 over an Asymmetric Digital Subscriber Line (ADSL) using an ADSL modem 106. ATM 104 communicates with a computer in the Internet 108 over a wireless connection established by two transceivers 112, 114 that exchange electromagnetic waves that are modified in a predetermined manner to indicate information. While ATMs 102, 104 may have different data transfer rates, each is coupled to the host computer 110 through a communications link that includes the Internet 108.

In FIG. 2, the system 200 includes four ATMs 202, 204, 206, 208 that are organized into two groups of two. Each group of ATMs is associated with a LAN server 210, 212 (LAN is an acronym for Local Area Network). System 200 can be used when multiple ATMs are associated with particular physical locations. For example, a bank or a shopping mall may have two or more ATMs. The first group of ATMs 202, 204 are coupled to LAN server 210. As one example, the ATMs 202, 204 can use an ethernet protocol (such as Ethernet, 100Base-T, or Gigabit Ethernet) and architecture to route messages to and from the LAN server 210. Other LAN protocols and architectures can also be used. The second group of ATMs 206, 208 are couple to LAN server 212. The LAN servers 210, 212 are coupled to the host computer 214, for example in a Wide Area Network (WAN). The communications between the LAN servers 210, 212 and the host computer 214 can travel through a public network such as the telephone system or the Internet. The communications between the LAN servers 210, 212 and the host computer 214 can also travel through private telecommunications devices such as a leased line or a satellite. While system 200 shows only two LAN servers 210, 212, additional LANs with two or more ATMs could be added. For example, a banking company may have hundreds of branches with each branch including one or more ATMs that are connected to a LAN for that branch. A LAN server employed with a particular bank branch can be called a branch controller. The LAN need not be dedicated to the ATMs. For example, computers used by branch employees may also be connected to the LAN and the WAN to send and receive information. As an alternative embodiment, the ATMs 202, 204 may only send information to the LAN server 210 and not to the host computer 214. An employee of the branch with LAN server 210 can then determine whether to send a group of ATM communications on to the host computer 214 or an automatic process can be performed, for example at the end of the day. A central facility 216 can also be provided to store information received from the ATMs. For example, the host computer 214 can store information received from the ATMs 202, 204, 206, 208 for a set time period and forward older information to be stored at the central facility 216.

While FIGS. 1 and 2 illustrate particular network configurations, many other configurations are possible. For example, a single ATM may communicate with a single computer through a dial-up link. In other words, the ATM establishes a call only as part of the process for sending a message and does not maintain the call at other times. Such a call can occur over a copper wire connection or using a wireless connection established by a mobile phone as two examples. In addition, many different communications protocols can be used to encode information transmitted from the ATM(s), including but not limited to Transmission Control Protocol/Internet Protocol (TCP/IP), Synchronous Optical NETwork (SONET), and Code Division Multiple Access (CDMA). The information transmitted using these protocols can be compressed prior to transmission using, for example, one of several known compression techniques. The communications hardware includes but not limited to electrical wires or cables, optical cables, and wireless transmitters and receivers.

In one embodiment, the ATMs shown in FIGS. 1 and 2 are accessible by customers for customer transactions. The ATMs can include buttons, a card scanner, or a touch-sensitive screen by which the ATM receive instructions and information from a customer. One example ATM may have a magnetic scanner, a screen, a group of number keys, and a group of buttons next to the screen. The ATM is programmed to have a transaction ready state where a customer can initiate a transaction by inserted a card with a magnetic strip into the magnetic scanner. The ATM can read the magnetic strip to determine what information is on the card. The ATM may have suitable hardware to read a card that uses other data storage, such as a chip-embedded card. The ATM can then display a request for a code to be entered using the number keys. The ATM can then wait a predetermined amount of time to receive the code. If the correct code is entered, the ATM can then provide options with a graphical indication of the button that corresponds to each option to guide the customer through a transaction. The example ATM with these structures is configured to allow customer transactions in which the ATM both displays information to the customer and receives information from the customer. The same structures can be used to perform administrative transactions. For example, a particular magnetic card and code can be used to initiate a transaction by a bank employee who inserted cash to replenish the ATM.

In general, the ATM may have the capabilities to perform general types of operations such as debit, credit, balance transfer, or balance inquiry operations. Certain of these general types of operations may have one or more specific implementations in the ATM based on the hardware capabilities and software configuration of the ATM. For example, the ATM may be able to perform a debit operation where the user enters the amount using the keypad (e.g., withdrawal) or a debit operation where the user selects an amount from a set of amounts (e.g., fast cash withdrawal).

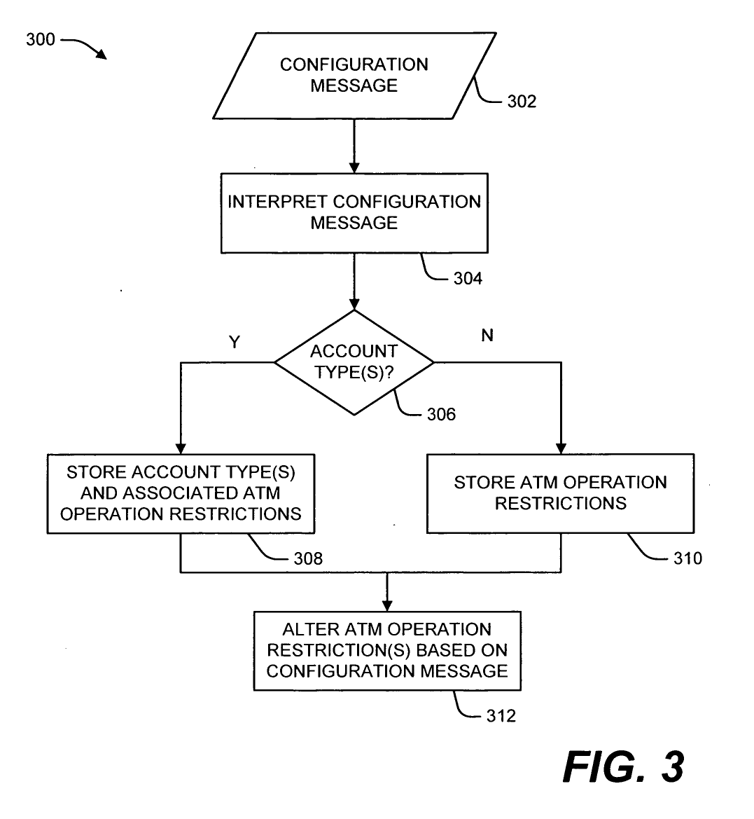

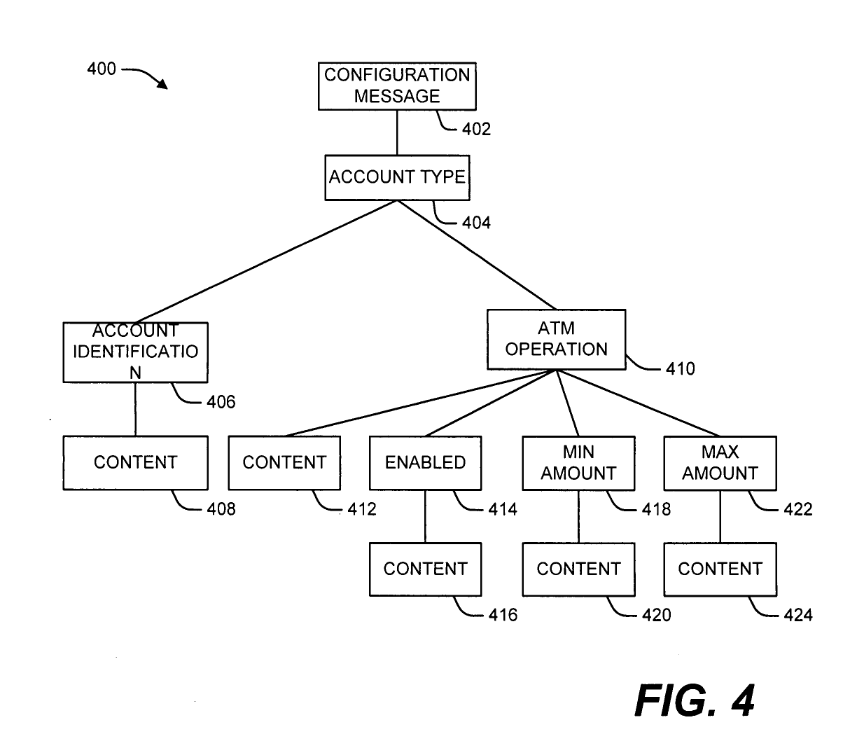

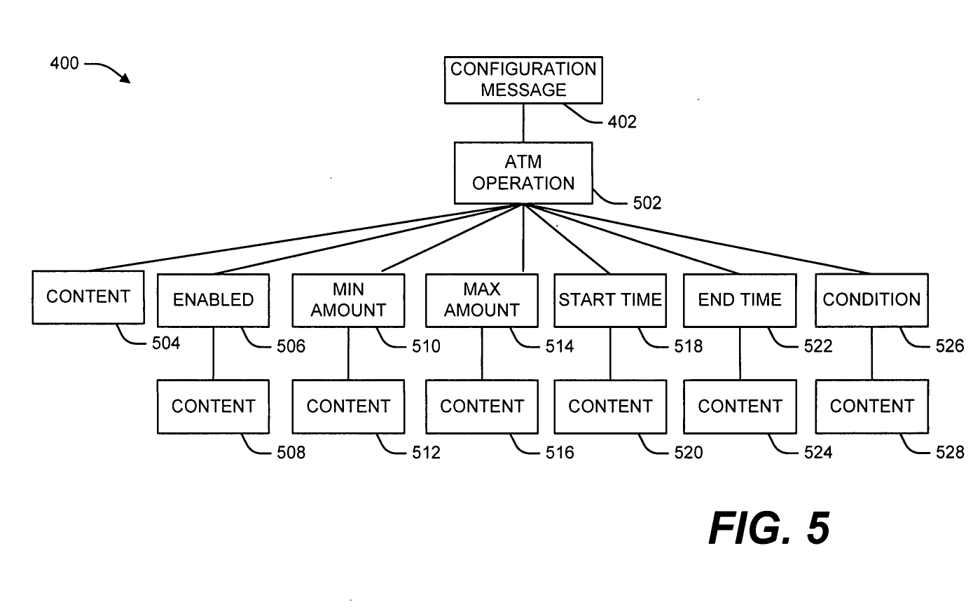

FIG. 3 is a flow chart of an example method of configuring the ATM, shown generally at 300. The ATM receives a configuration message from a computer, such as the host computer 110 (block 302). The configuration message may include data that is in an XML format. Example structures of configuration messages are shown in FIGS. 4 and 5. The ATM interprets the configuration message (block 304) and determines whether the configuration message alters one or more ATM operation restrictions based on one or more account types (block 306). In general, an account type refers to a class of account (e.g., checking, saving, credit) at an issuing institution or group of issuing institutions. In certain implementations, a checking account at a first bank may have a different account type than a checking account at a second bank. Likewise, in certain implementations, a savings account at the first bank may have a different account type than the checking account at the first bank.

If the configuration message does alters one or more ATM operation restrictions based on one or more account types (block 305), then the ATM stores the one or more account types and one or more associated ATM operation restrictions (block 308). In certain implementations, the ATM may store the account types and one or more associated ATM operation restrictions in a logical object, which may be referred to as an account type object.

If the configuration message does alters one or more ATM operation restrictions based on one or more account types (block 305), then the ATM stores the ATM operation restrictions (block 310). In certain implementations, the ATM may store these ATM operation restrictions in a logical object, which may be referred to as a transaction object.

After either of blocks 308 or 310, the ATM alters the restrictions of ATM operations based on the configuration message (block 312). In certain example implementations, the restrictions on ATM operations include unconditionally enabling or disabling an ATM operation. In other example implementations, the restrictions on ATM operations include conditionally enabling or disabling based on one or more conditions. Example conditions include minimum and maximum transaction amounts. In certain implementations, the ATM may restrict withdrawals to amounts within a minimum and maximum amount. Other example conditions include one or more times which may be represented as date and/or time of day. For example, deposits may be disabled for a range of time when the ATM is busy. In other example implementations, the ATM operation restrictions are based on device parameters of the ATM. For example, certain ATM operations may be disabled when malfunctions are detected in one or more portions of the ATM. In still other example implementations, the ATM operation restrictions are based on business interests. In still other example implementations, one or more ATM operations are restricted if the ATM is operating in an offline mode.

FIG. 4 show an example data structure 400 of a configuration message received by the ATM in block 305. The message information is stored in nested tags. Each of the tags can include data and/or tags contained within it. The top level tag is a configuration message tag 402. The configuration message tag 402 includes one account type tag 404. In general, the configuration message tag 402 includes zero or more account type tags 404. The account type tag 404 includes an account identification tag 406, which includes content 408 to indicate the identity of the account type. In general, the account type tag 404 includes one or more account identification tags 406. In certain implementations, the content 408 includes a portion of an account number that accounts of the account type share. The account type 404 tag also includes an ATM operation tag 410, which includes content 412 to identify the ATM operation restricted by the ATM operation tag 410. The ATM operation tag 410 includes an enabled tag 414, which in turn includes content 416 to indicate whether the ATM operation controlled by ATM operation tag 410 is enabled or disabled. The ATM operation tag 410 includes a min amount 418 tag and a max amount tag 422, which include contents 420 and 424, respectively, to indicate minimum and maximum amounts respectively. In this implementation, the ATM operation would be restricted to amounts between the contents 420 and 424. In certain implementations, either or both of min amount tag 418 or max amount tag 422 are omitted. In still other implementations, other conditional tags and associated contents are included in ATM operation tag 410.

FIG. 5 shows another example data structure 400 of a configuration message received by the ATM in block 305. The example data structure includes an ATM operation tag 502 immediately within the configuration message tag 402, indicating that example ATM operation restriction applies to the ATM, regardless of account type. In general, the configuration message tag 402 includes zero or more ATM operation tags 502 at this level of nesting. In certain implementations, the ATM operation tag 502 and tags nested inside it may be named differently to distinguish from ATM operation tags (such as ATM operation tag 410) within an account type tag 404. The ATM operation tag 502 includes content 504 to indicate which one or more ATM operations are controlled by this tag. The ATM operation tag 502 includes an enable tag 506, with content 508 to indicate whether the ATM operation is enabled or disabled. The ATM operation tag 502 includes a min amount tag 510 and a max amount tag 514, which, in turn, include contents 512 and 516, respectively, to indicate minimum and maximum transaction amounts for the ATM operation. Certain implementations omit one or both of the min amount tag 510 and the max amount tag 514 to indicate, for example, that the ATM operation has no minimum or maximum transaction amount. The ATM operation tag 502 includes a start time tag 518 and an end time tag 522 with contents 520 and 524, respectively, to indicate start and end times for the ATM operation restriction. Certain implementations omit one or both of a start time tag 518 and an end time tag 522 to indicate, for example, that the ATM operation restriction is to start immediately or last indefinitely. The ATM operation tag 502 includes a generic condition tag 526 with associated content 528 to illustrate that one or more other conditions are included in some example implementations. The data structures of FIGS. 3 and 4 are just two possible formats of a configuration message that is received by the ATM in block 305.

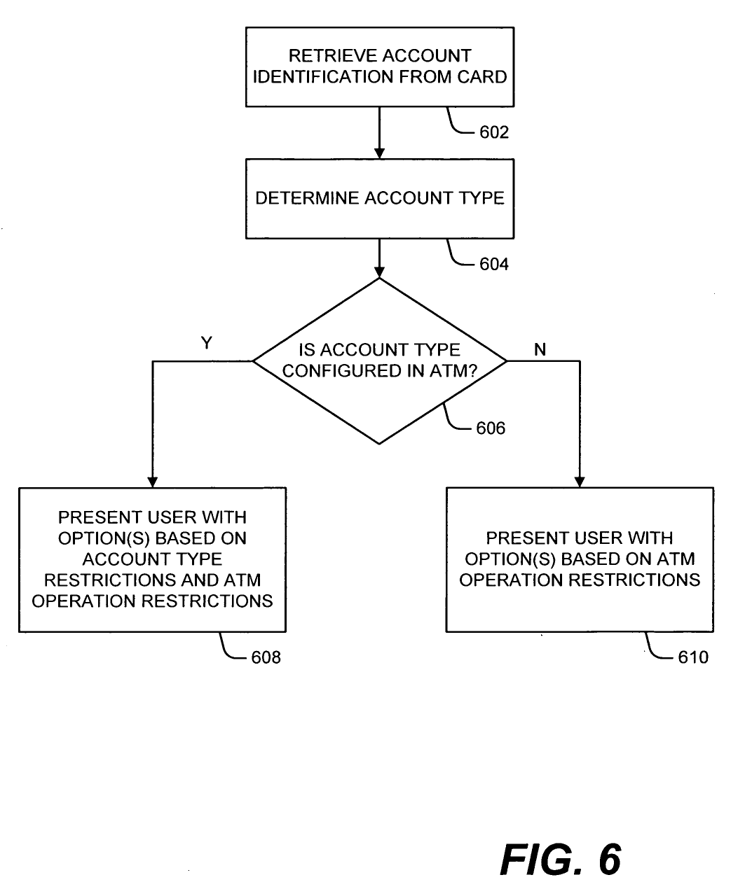

FIG. 6 is a flowchart of a method of operating a configured ATM according to an exemplary embodiment. The user initiates the method by, for example, inserting a card into the ATM (not shown). The ATM retrieves account identification for the card (block 602) and determines the account type based on the account identification of the card. As described above, in certain implementations, the ATM determines the account type based on a portion of the account number stored on the card. The ATM determines whether the account type is configured in the ATM (block 606) and, if so, the ATM presents the user with zero or more options based on account type ATM operation restrictions and non-account type ATM operation restrictions (block 608). In certain implementations, where an ATM operation has been configured by both an account type ATM operation restrictions and a non-account type ATM operation restrictions, the ATM will present the more restrictive of the one or more account type ATM operation restrictions and the one or more non-account type ATM operation restrictions. In other implementations, the least restrictive restriction is presented. If the account type is not configured in the ATM (block 606), the ATM presents the user with options based on non-account type ATM operation restrictions.

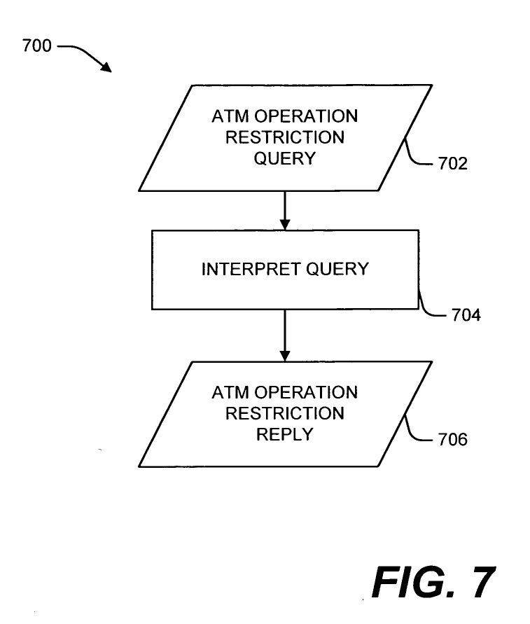

FIG. 7 is a flowchart of a method 700 of querying an ATM according to an exemplary embodiment. The ATM receives an ATM operation restriction query message from a computer, such as computer 110. The ATM operation restriction query may request all or part of the ATM's stored ATM operation restrictions. Certain implementations request both one or more account type ATM operation restrictions and one or more non-account type ATM operation restrictions. Other implementations request only account type ATM operation restrictions and one or more non-account type ATM operation restrictions. The ATM interprets the query (block 704) and returns an ATM operation restriction reply message with the requested restrictions. The method 700 allows a host computer 110 to determine a current configuration of the ATM's ATM operation restrictions. Some example implementations include querying the ATM periodically and altering the ATM's ATM operation restrictions when they become incorrect or out of date.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for configuring an automated teller machine (ATM), comprising:
receiving at an ATM one or more configuration messages;
interpreting the one or more configuration messages; and
altering one or more restrictions of one or more ATM operations based on at least a portion of the one or more configuration messages,
wherein the one or more configuration messages are in an XML-based format.

2. The method of claim 1, further comprising:
storing at the ATM one or more account types and one or more associated transaction restrictions.

3. The method of claim 1, where altering one or more restrictions of one or more ATM operations based on at least a portion of the one or more configuration messages further comprises:
altering one or more restrictions of one or more ATM operations based on an account type.

4. The method of claim 3, where a user of the ATM is associated with an account type, the method further comprising:
presenting the user with one or more options based on the account type associated with the user.

5. The method of claim 3, where altering one or more restrictions of one or more ATM operations based on the account type, further comprises:
restricting a transaction amount of one or more operations based on the account type.

6. The method of claim 3, where restricting the transaction of the ATM based on the account type further comprises:
disallowing one or more of the one or more operations based on the account type.

7. The method of claim 1, where altering one or more restrictions of one or more ATM operations based on at least a portion of the one or more configuration messages further comprises:
altering one or more restrictions of one or more ATM operations based on a time.

8. The method of claim 1, where altering one or more restrictions of one or more ATM operations based on at least a portion of the one or more configuration messages further comprises:
altering one or more restrictions of one or more ATM operations based on one or more device limitations of the ATM.

9. The method of claim 1, where the ATM is coupled to a computer, the method further comprising:
at the computer, querying the ATM to determine one more restrictions of the one or more ATM operations; and
at the ATM, responding to the computer with one or more messages indicating the one or more restrictions of the one or more ATM operations.

10. A system for configuring an automated teller machine (ATM), comprising:
an ATM configured to receive and interpret one or more configuration messages and alter one or more restrictions of one or more ATM operations based on at least a portion of the one or more configuration messages;
a communication link coupled to the ATM; and
a computer coupled to the communication link,
wherein the ATM is configured to receive the one or more configuration messages in an XML-based format.

11. The system of claim 10, where the ATM is configured to store one or more account types and one or more associated transaction restrictions.

12. The system of claim 10, where the ATM is configured to alter the one or more restrictions of one or more ATM operations based on an account type.

13. The system of claim 10, where a user of the ATM is associated with an account type, and where the ATM is configured to present the user with one or more options based on the account type associated with the user.

14. The system of claim 10, where the ATM is configured to restrict a transaction amount of one or more operations based on the account type.

15. The system of claim 10, where the ATM is configured to alter the one or more restrictions of one or more ATM operations based on a time.

16. The system of claim 10, where the computer is configured to querying the ATM to determine one more restrictions of the one or more ATM operations and the ATM is configured to respond to the computer with one or more messages indicating the one or more restrictions of the one or more ATM operations.

17. Computer software, stored on a tangible storage medium, for operating an automated teller machine (ATM), the software comprising executable instructions that cause at least one computer to:
receive at an ATM one or more configuration messages;
interpret the one or more configuration messages; and
alter one or more restrictions of one or more ATM operations based on at least a portion of the one or more configuration messages,
wherein the one or more configuration messages are in an XML-based format.

18. The software of claim 17, further comprising instructions that cause the at least one computer to:
store at the ATM one or more account types and one or more associated transaction parameters.

19. The software of claim 17, where the executable instructions that cause the at least one computer to alter the one or more restrictions of one or more ATM operations based on at least a portion of the one or more configuration messages further cause the at least one computer to:
alter the one or more restrictions of one or more ATM operations based on an account type.

20. The software of claim 19, where a user of the ATM is associated with an account type, and where the executable instructions further cause the at least one computer to:
present the user with one or more options based on the account type associated with the user.

21. The software of claim 19, where the executable instruction that cause the at least one computer to alter the one or more restrictions of one or more ATM operations based on the account type further cause the at least one computer to:
restrict a transaction amount of one or more operations based on the account type.

22. The software of claim 19, where the executable instruction that cause the at least one computer to alter the one or more restrictions of one or more ATM operations based on the account type further cause the at least one computer to:
disallow one or more of the one or more operations based on the account type.

23. The software of claim 17, where the executable instructions that cause the at least one computer to alter the one or more restrictions of one or more ATM operations based on at least a portion of the one or more configuration messages further cause the at least one computer to:
alter the one or more restrictions of one or more ATM operations based on a time.

24. The software of claim 17, where the executable instructions that cause the at least one computer to alter the one or more restrictions of one or more ATM operations based on at least a portion of the one or more configuration messages further cause the at least one computer to:
alter the one or more restrictions of one or more ATM operations based on one or more device limitations of the ATM.

25. The software of claim 17, where the ATM is coupled to a remote computer, and where the executable instruction further cause the at least one computer to:
receive a query from the remote computer, the query to determine one more restrictions on the one or more ATM operations; and
respond to the remote computer with one or more messages indicating the one or more restrictions of the one or more ATM operations.
